(19) United States
(12) Patent Application Publication
(10) Pub. No.: US 2012/0198674 A1
(43) Pub. Date: Aug. 9, 2012

(54) Removal Tool

(76) Inventor: Evan Krause, Plainfield, IL (US)

(21) Appl. No.: 13/021,727

(22) Filed: Feb. 5, 2011

(51) Int. Cl. B23P 19/00

(52) U.S. Cl. 29/221.6

(57) ABSTRACT

A tool to remove a Schrader valve may include a grappling collet to engage the Schrader valve, a valve adapter to connect to an isolation valve, and an extractor head to cooperate with the grappling collet and the Schrader valve. The grappling collet may include a first jaw to engage the Schrader valve, and the grappling collet may include a second jaw to engage the Schrader valve. The tool may include a retractor handle to retract the grappling collet, and a tool may include an extractor device to extract the grappling collet. The extractor device may be biased to extract the grappling collet, and the extractor device may be biased with the spring. The valve adapter may include an exhaust aperture.

### FIELD OF THE INVENTION

The present invention relates generally to method and apparatus for maintaining and servicing a pressurized system such as a refrigeration system or the like, and more particularly, but not by way of limitation, to method and apparatus for removing and replacing a closure member in a pressurized refrigeration system.

### BACKGROUND

It is known that valve cores, such as the Schrader-type used in refrigeration systems are typically not subject to high quality control, resulting in a significant number valve cores that are initially installed in refrigeration systems being incapable of maintaining the proper operating pressure to permit efficient operation of the refrigeration system. It is also common for a Schrader type valve needing to be replaced to become stuck. Additionally, refrigeration systems, while they are intended to be closed (sealed) systems, are actually made from a number of other components, with various fittings and seals, subject to leakage. It is necessary to repair and recharge the refrigeration systems in an efficient way, such as through the removal of the core valve, thus providing access for refrigerant removal, system evacuation and recharge. The removal of the core valve, which is under high pressure, will tend to blow out the core valve, until the interior pressure of the tool is equalized. The prior art contains a number of teachings of servicing tools which provide access to a refrigeration system or the like to evacuate or charge the system.

One such tool is disclosed in U.S. Pat. No. 3,299,648, issued to White, et al.

It is, therefore, necessary many times to replace an unsatisfactory valve core after charging a refrigeration system with refrigerant. It is to this industry-wide problem that the method and apparatus of the present invention is directed.

### SUMMARY

A tool to remove a Schrader valve may include a grappling collet to engage the Schrader valve, a valve adapter to connect to an isolation valve, and an extractor head to cooperate with the grappling collet and the Schrader valve.

The grappling collet may include a first jaw to engage the Schrader valve, and the grappling collet may include a second jaw to engage the Schrader valve.

The tool may include a retractor handle to retract the grappling collet, and a tool may include an extractor device to extract the grappling collet.

The retractor handle may be biased to retract the grappling collet, and the extractor device may be biased with the spring.

The valve adapter may include an exhaust aperture.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the grappling collet of the present invention;

FIG. 2 illustrates a portion of the grappling collet of the present invention;

FIG. 3 illustrates a top view of the grappling collet of the present invention;

FIG. 4 illustrates a bottom view of the grappling collet of the present invention;

FIG. 5 illustrates a perspective view of the valve adapter of the present invention;

FIG. 6 illustrates a top view of the valve adapter of the present invention;

FIG. 7 illustrates a bottom view of the valve adapter of the present invention;

FIG. 8 illustrates a sectional view of the valve adapter of the present invention;

FIG. 9 illustrates a perspective view of the retractor handle of the present invention;

FIG. 10 illustrates a top view of the retractor handle of the present invention;

FIG. 11 illustrates a bottom view of the retractor handle of the present invention;

FIG. 12 illustrates a perspective view of the extractor handle of the present invention;

FIG. 13 illustrates a top view of the extractor handle of the present invention;

FIG. 14 illustrates a bottom view of the extractor handle of the present invention;

FIG. 15 illustrates a sectional view of the extractor head of the present invention;

FIG. 16 illustrates a top view of the extractor head of the present invention;

FIG. 17 illustrates a bottom view of the extractor head of the present invention;

FIG. 18 illustrates a cross sectional view of the extractor head of the present invention;

FIG. 19 illustrates an exploded view of the tool of the present invention, an isolation valve and a Schrader valve;

FIG. 20 illustrates a cross-sectional view of the isolation valve and the Schrader valve;

FIG. 21 illustrates a cross-sectional view of the tool of the present invention, an isolation valve and a Schrader valve;

FIG. 22 illustrates a cross-sectional view of the tool of the present invention, an isolation valve and a Schrader valve;

FIG. 23 illustrates a cross-sectional view of the tool of the present invention, an isolation valve and a Schrader valve;

FIG. 24 illustrates a cross-sectional view of the extractor tool of the present invention;

FIG. 25 illustrates a thread fixer of the present invention;

FIG. 26 illustrates a valve core remover of the present invention.

### DETAILED DESCRIPTION

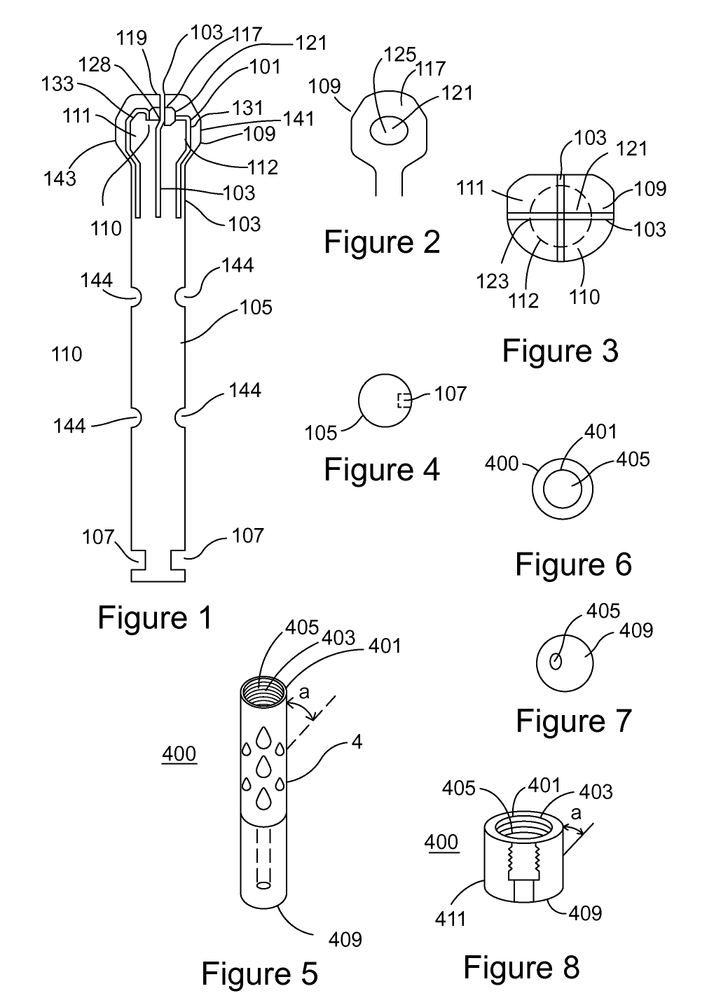

FIG. 1 illustrates a cross-sectional view of the grappling collet 100 of the present invention which may include a main body 105 which may be a cylindrical shaped body which may include expandable jaws 101 which may expand and contract in order to hold a Schrader valve which may be mounted on an upper end of the main body 105. The lower end of the main body may include a traverse channel 107 and the expandable jaws 101 may include a first expandable jaw 109 and a second expandable jaw 111 which may be positioned in an opposing relationship in order to grasp the Schrader valve. Other embodiments may include four jaws. The first expandable jaw 109 and the second expandable jaw 111 may be defined by a longitudinal slit 103 which may expand in the longitudinal direction of the expandable jaws 101. A third expandable jaw 110 and a fourth expandable jaw 112 which may be positioned in an opposing relationship and defined by a second longitudinal slit 103. More particularly, the longitudinal slit 103 may define a first opposed surface 117 of the first opposed jaw 109 and a second opposed surface 119 of the second opposed jaw 111. The first opposed surface 117 may include a first depression 121 and the second opposed surface 119 may include a second depression 123. The surface 125 of the first depression 121 may be substantially sized to surround the Schrader valve and the surface of the second depression 123 may be substantially sized to surround the Schrader valve to allow the Schrader valve to be securely held. Grooves 144 may have an O-ring to prevent exhaust gas from escaping between the collet shaft 100 and the extractor 1500.

A first passageway 131 may extend from the first depression 121 to the exhaust gas which may be expelled from the removal of the Schrader valve, and the second passageway 133 may extend from the second depression 123 again to the exhaust gas which may be expelled from the removal of the Schrader valve.

The first opposed jaw 109 may include an exterior surface 141 which may be curved or may include inclined surface sections in order to close around the Schrader valve in order to be securely held.

FIG. 2 illustrates a section of the first opposed jaw 109 which may be a mirror of the second opposed jaw 111 and illustrates the first opposed surface 117 and the first depression 121.

FIG. 3 illustrates a top view of the collet 100 and more particularly illustrates the first opposed jaw 109, the third opposed jaw 110, the second opposed jaw 111 and a fourth opposed jaw 112 and illustrates the slit 103 that may define the first opposed jaw 109, the third opposed jaw 110, the fourth opposed jaw 112 and the second opposed jaw 111 and may define the first opposed surface 117 and the second surface 119. A second slit may define the four jaws. The collet 100 may be hollow to cooperate with the schrader valve to be held securely when the collet 100 is retracted into the tip 1503 as shown in FIG. 18.

FIG. 4 illustrates a bottom view of the main body 105 and illustrates the traverse channel 107 which may go around the entire circumference of the collet 100 for the purpose of securing the collet 100 to the retractor handle with a mechanical connector.

FIG. 5 illustrates a perspective view of the valve adapter or protective sleeve 400 which may include a cylinder shaped device to exhaust pressurized fluid which may escape from the Schrader valve. The protective sleeve 400 may include a central aperture 405 which may extend through the protective sleeve 400 between the first end 401 and the second end 409 and the protective sleeve 400 may include internal threads 403 at a first end 401. The protective sleeve 400 may include inclined apertures 407 which may extend through the protective sleeve 400 to the central aperture 405 and may be angled at an angle ‘a’ towards the first end 401.

FIG. 6 illustrates a top view of the protective sleeve 400 and illustrates the first end 401 and the central aperture 405.

FIG. 7 illustrates a bottom view of the protective sleeve 400 and illustrates the second end 409 and the central aperture 405.

FIG. 8 illustrates a sectional view of an alternative valve adapter. The valve adapter may contain multiple O-rings to prevent pressurized fluids from escaping. O-rings provide a seal between the protective sleeve 400 and the main body 1500 and also between the protective sleeve 400 and the isolation valve 1901. The extractor 1500 slides through the central aperture 405, second and 1519 through the first end 401. The protective sleeve 400 may include a central aperture 405 which may extend through the protective sleeve 400 between the first end 401 and the second end 409 and the protective sleeve 400 may include internal threads 403 at a first end 401 to provide a mechanical connection to the isolation valve 1901. The valve adapter 400 surface may be knurled to improve grip. FIG. 8 additionally illustrates a fastening device 411 which may provide a frictional fit to the main body 1500 and may be multiple o rings.

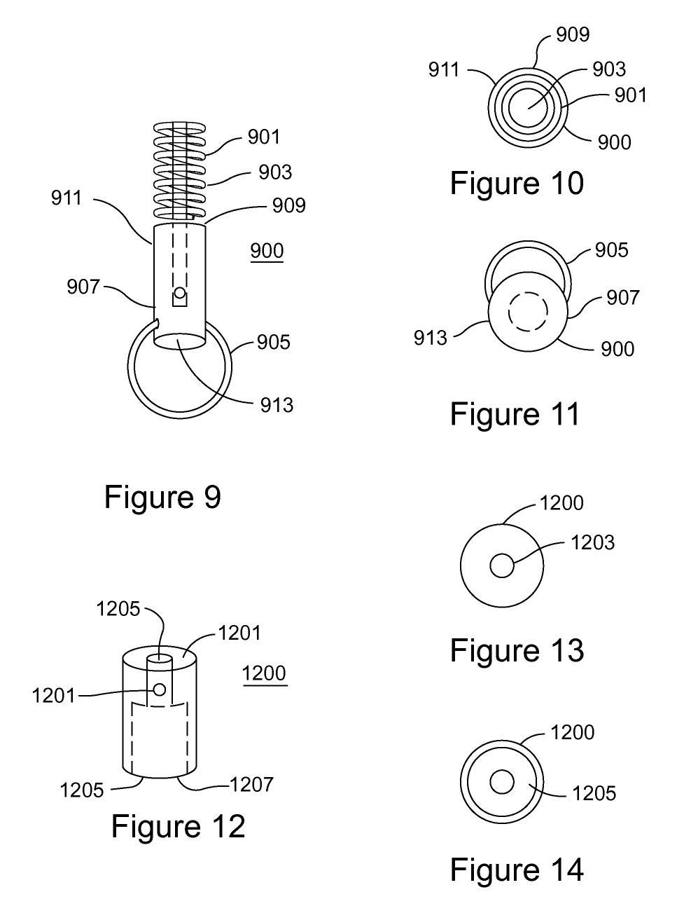

FIG. 9 illustrates a perspective view of a retractor handle 900 which may be a substantial cylinder device which may include a biasing device 901 which may be a spring to bias the collet 100 and to extend and retract the collet 100. The retractor handle 900 may include a central aperture 903 to cooperate with the main body 105 and may include a ring device 905 which may be connected to the second end 913 to allow the retractor handle 900 to be pulled by the user while twisting extractor device 1200 to dislodge stuck Schrader valves and to be positioned on a carrying device such as a belt or to be carried by hand. The retractor handle 900 may include a protruding lip 909 which may extend outwards from the first end 911 of the retractor handle 900 and which may be a cylindrical in shape. The central aperture 903 may be in communication with a releasable locking device 907 which may be a set screw in order to retain and release the main body 105.

FIG. 10 illustrates a top view of the retractor handle 900 and illustrates the biasing device 901, the central aperture 903 and the projecting lip 909 of the first end 911.

FIG. 11 illustrates a bottom view of the retractor handle 900 and illustrates the ring device 905, the adjustable locking device 907 at the second end 913.

FIG. 12 illustrates a perspective view of the extractor device 1200 which may include a first aperture 1203 at a first end 1201 of the extractor device 1200 and may include a second aperture 1207 at a second end 1205 of the extractor device 1200 which may be in communication with the first aperture 1203 and which may be larger in diameter than the first aperture 1203 and which may cooperate with the biasing device 901 of the retractor handle 900. The surface 1209 which defines the first aperture 1203 may include female threads which may be left-handed threads in order to cooperate with a threaded end of the extractor head 1500 in order to remain detachably connected to the extractor head 1500. In addition, the extractor device 1200 may include a fastener device 1211 which may be a set screw to releasably hold the extractor head 1500 surface may be knurled for an improved grip.

FIG. 13 illustrates a top view of the extractor device 1200 and illustrates the first central aperture 1203.

FIG. 14 illustrates a bottom view of the extractor device 1200 and illustrates the second central aperture 1207.

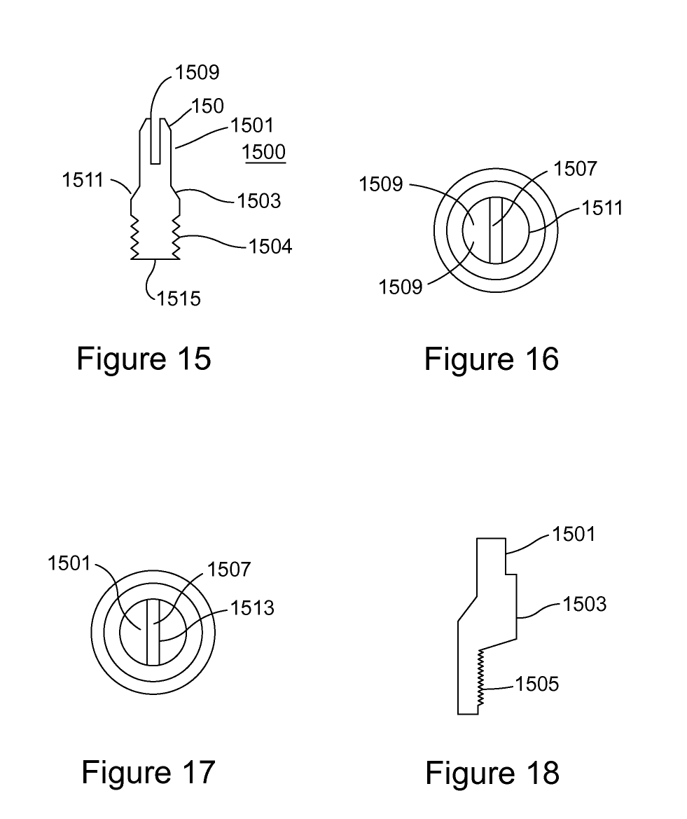

FIG. 15 illustrates a cross-sectional view of the extractor head 1500 which may include a tip portion 1501, a middle portion 1503 and a connector portion 1505. The tip portion may include a cylinder shaped device having a central slit 1507 which may extend across the top portion 1501 and may include a central tip aperture 1509 which may extend through the tip portion 1501. The middle portion 1503 may include inclined outer surface 1511 and a inclined interior surface 1511 to form a truncated cone in order to cooperate with the extendable jaws 101 by forcing the extendable jaws 101 to close around the Schrader valve as the collet 100 is retracted back into the middle portion 1503 from the biasing device 901.

The connector portion 1505 may be substantially a cylinder shaped device and may include a central connector aperture 1515 to communicate with the middle portion 1503 and may include internal threads for connection to the element 1517.

FIG. 16 illustrates a top view of the extractor head 1500 and illustrates the central slit 1507, the inclined exterior surface 1511 of the middle portion 1503, the top portion 1501 and a middle portion 1503.

FIG. 17 illustrates a bottom view of the extractor head 1500 and illustrates the central slit 1507, the inclined interior surface 1513 of the middle portion 1503, the top portion 1501 and a middle portion 1503.

FIG. 18 illustrates a sectional view of the extractor head 1500 and may include the tip portion 1501, the middle portion 1503 and the connector portion 1505.

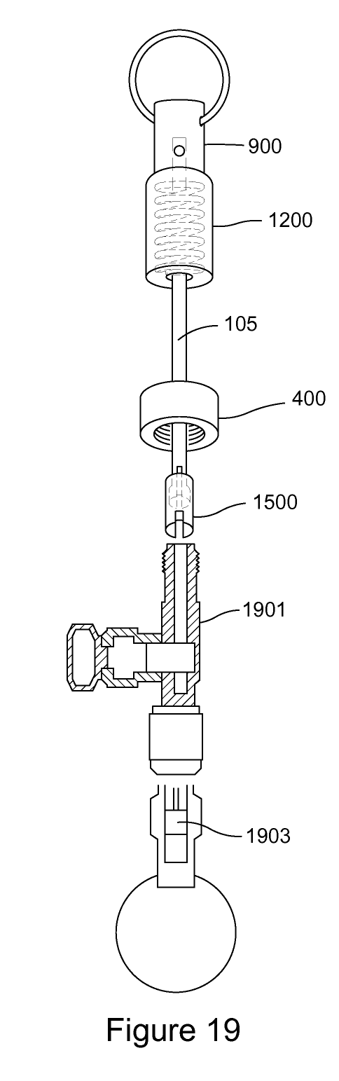

FIG. 19 illustrates the grappling collet 100 in a first position or retracted position, the valve adapter 400, the retractor handle 900, the extractor device 1500, the extractor handle 1200, and the isolation valve 1901 to connect with the valve adapter 400 and to connect to the Schrader valve 1903.

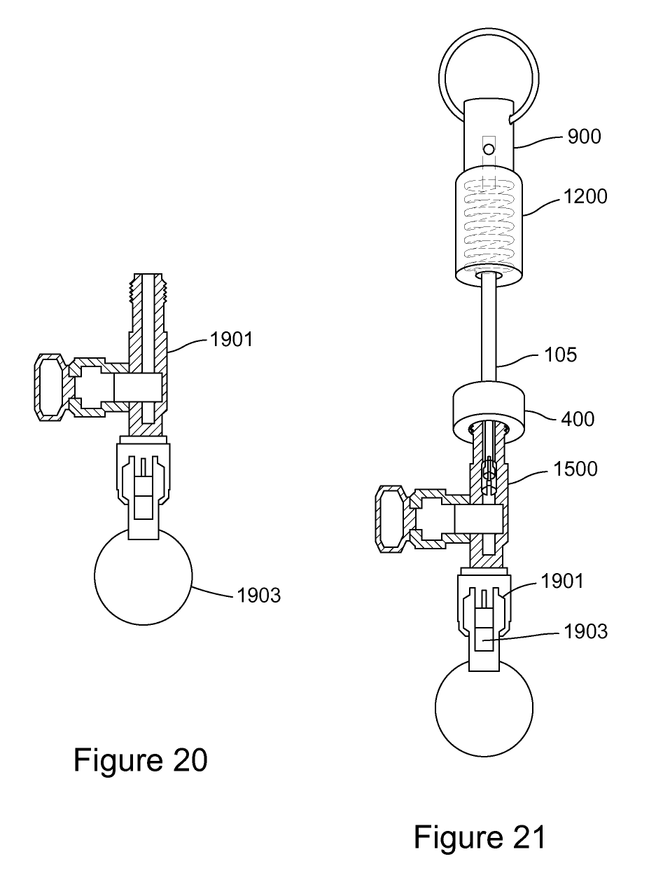

FIG. 20 illustrates the isolation valve 1901 being connected to the Schrader valve 1903 by a threaded connection.

FIG. 21 illustrates the grappling collet 100 in a first position or retracted position, the valve adapter 400, the retractor handle 900, the extractor handle 1200, the extractor device 1500, and the isolation valve 1901 to connect with the valve adapter 400 and to connect to the Schrader valve 1903. FIG. 21 additionally illustrates that the valve adapter 400 may be connected to the isolation valve 1901 by connecting the internal threads of the valve adapter 400 to the external threads of the isolation valve 1901. The isolation valve 1901 is shown in the closed position.

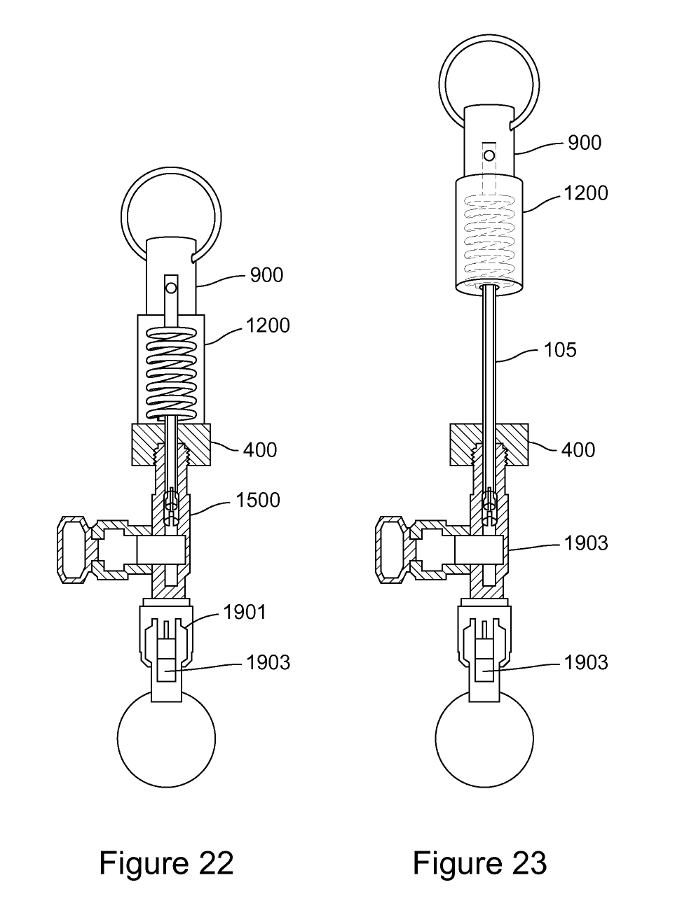

FIG. 22 illustrates the grappling collet 100 in a second position or extended position, the valve adapter 400, the retractor handle 900, the extractor handle 1200, the extractor device 1500, and the isolation valve 1901 to connect with the valve adapter 400 and to connect to the Schrader valve 1903. The isolation valve 1901 may be opened and the grappling collet 100 is extended to the valve core of the Schrader valve 1903 allowing the jaws 101 of the grappling collet to open to grasp the ball at the tip of the valve core of the Schrader valve 1903. The retractor handle 900 is extended away from the isolation valve 1901 by the by spring 1901 and the Schrader valve 1903 to lock the jaws 101 of the grappling collet 100 onto the valve core of the Schrader valve 1903.

FIG. 23 illustrates the grappling collet 100 in a first position or retracted position, the valve adapter 400, the retractor handle 900, the extractor handle 1200, the extractor device 1500, and the isolation valve 1901 to connect with the valve adapter 400 and to connect to the Schrader valve 1903.

The extractor handle 1200 is rotated to remove or install the Schrader valve core 1903 with the cooperation of the extractor device 1500. The bias of the biasing device 901 may be sufficient to retain the jaws of the grappling collet 100 on the valve core of the Schrader valve 1903.

The valve core may be removed and the isolation valve 1901 may be closed.

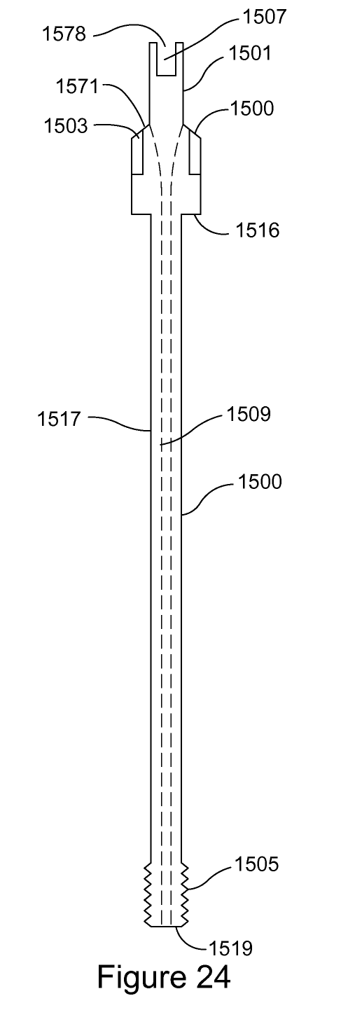

FIG. 24 illustrates a cross-sectional view of the extractor device 1500 which may include a tip portion 1501, a middle portion 1517 and a connector portion 1505. The tip portion may include a cylinder shaped device having a central slit 1507 which may extend across the top portion 1501 and may include a central tip aperture 1509 which may extend through the top portion 1501 and middle portion 1517. The middle portion 1503 may include inclined outer surface 1511 and a inclined interior surface 1511 to form a truncated cone in order to cooperate with the extendable jaws 101 by forcing the extendable jaws 101 to close around the Schrader valve as the collet 100 is retracted back into the middle portion 1503 from the biasing device 901.

FIG. 26 illustrates a cross-sectional view of the extractor tool of the present invention to remove the cone shaped lower end of the valve core. FIG. 26 illustrates a cone shaped end.

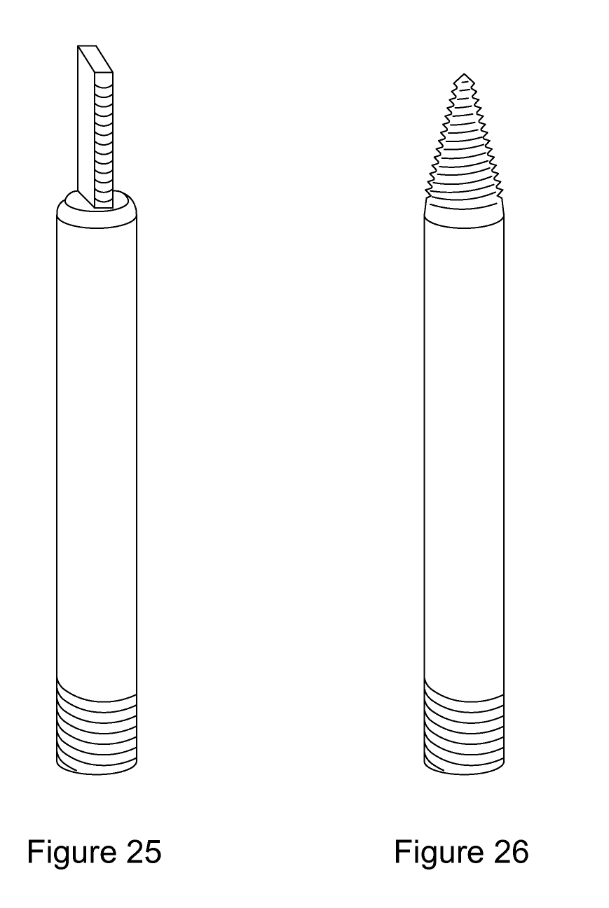

FIG. 25 illustrates a thread fixer of the present invention to repair threads.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A tool to remove a Schrader valve, comprising:
a grappling collet to engage the Schrader valve;
a valve adapter to connect to an isolation valve;
an extractor head to cooperate with the grappling collet and the Schrader valve.

2) A tool to remove a Schrader valve as in claim 1, wherein the grappling collet includes a first jaw to engage the Schrader valve.

3) A tool to remove a Schrader valve as in claim 2, wherein the grappling collet includes a second jaw to engage the Schrader valve.

4) A tool to remove a Schrader valve as in claim 1, wherein the tool includes a retractor handle to retract the grappling collet.

5) A tool to remove a Schrader valve as in claim 1, wherein the tool includes an extractor device to extract the grappling collet.

6) A tool to remove a Schrader valve as in claim 5, wherein the extractor device is biased to extract the grappling collet.

7) A tool to remove a Schrader valve as in claim 6, wherein the extractor device is biased with the spring.

8) A tool to remove a Schrader valve as in claim 1, wherein the valve adapter includes an exhaust aperture.
